(19) United States
(12) Patent Application Publication
(10) Pub. No.: US 2009/0084712 A1
(43) Pub. Date: Apr. 2, 2009

(54) SIEVE

(76) Inventor: Juergen Moosmann, Berg (DE)

Correspondence Address: BUCHANAN, INGERSOLL & ROONEY PC, POST OFFICE BOX 1404, ALEXANDRIA, VA, 22313-1404, US

(21) Appl. No.: 12/278,539

(22) PCT Filed: Jan. 26, 2007
(86) PCT No.: PCT/CH07/00035

§ 371 Date: Sep. 25, 2008

(30) Foreign Application Priority Data
Feb. 8, 2006 (DE) 10 2006 005 967.0

(51) Int. Cl. B07B 1/46

(52) U.S. Cl. 209/412

(57) ABSTRACT

A sieve is disclosed which can, for example, be used in plansifters or similar sieving and screening devices for screening mealy or granular products. To increase screening performance, there is provided at least one drop-through channel whose width is, for example, at least 1.5 times that of known sieves.

The invention relates to a sieve, in particular a sieve for use in plan sifters or similar sieving and sifting devices for sifting mealy, granular or particulate products.

EP-B-584302 discloses devices for plan sifters, in particular also sieves and sieve frames. Sieves of this type comprise a sieve box with a base plate and an outlet for fine product as well as a sieve frame spanned by a sieve mesh. The sieve frame, like the sieve box also, is divided into sections by means of battens, is free from connecting elements and can be inserted in an interlocking mariner into the sieve box. An insertable sieve frame of this type has sufficient inherent rigidity for it not to become deformed and not to have to be fixed to the sieve box with fixing elements. The sieve frame is preferably made of metal materials and is spanned with sieve mesh. The surfaces of the sieve box which come into contact with the product are preferably coated with plastics material and the base plate consists of metal or plastics material.

It is also known to produce sieve frames from plastics materials and to provide a metal skeleton for reinforcement. The sieve mesh can be connected to the sieve frame by surrounding them with foam.

It is further known from DE-A-10105647 to foam sieve boxes of this type using a plastics material. In this embodiment, a batten is formed by a further insert in the foaming mould which is floatingly mounted during foaming and can shrink freely during cooling.

The object of the invention is to develop a sieve which is better adapted to the product flow in the sifter, in particular plan sifter, and which is suitable in particular for very high outputs. The object is achieved by the features of claim 1. The sieve box comprises at least one sifting channel, the width of which is substantially wider than usual (conventional width is approx. 6 cm), preferably at least 1.5 times wider. For example, a width of approx. 13 cm.

Advantageous developments are disclosed in the sub-claims. Two large discharge channels are preferably provided, which are arranged parallel to one another on the outer sides of the sieve box. Sieves with large sifting channels of this type for the overflow can be used, in particular, for control sifting in the case of high outputs of, for example, up to 40 t/h per sieve section. They also allow better air circulation in plan sifters.

The external dimensions (base area) of the sieve are preferably equal in all embodiments.

In a further development the sieve boxes are preferably foamed and provided with insertable sieves, the frames of which consist of metal, preferably stainless steel, according to the disclosure of EP-B-584302.

The discharge box preferably has a modular construction, which allows a great variety of discharge variants with a lower number of moulded parts, also with regard to the number of product runs.

An embodiment of the invention will be described in greater detail hereinafter with reference to drawings, in which:

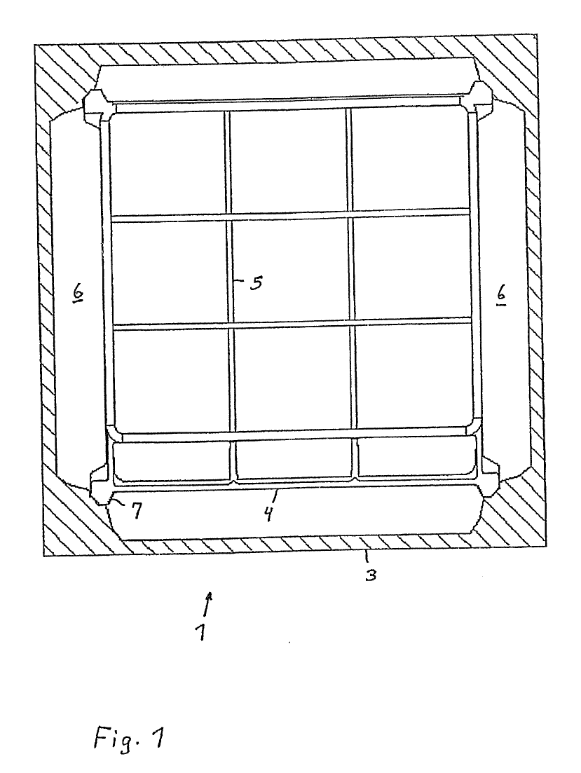

FIG. 1 is a plan view of a sieve box,

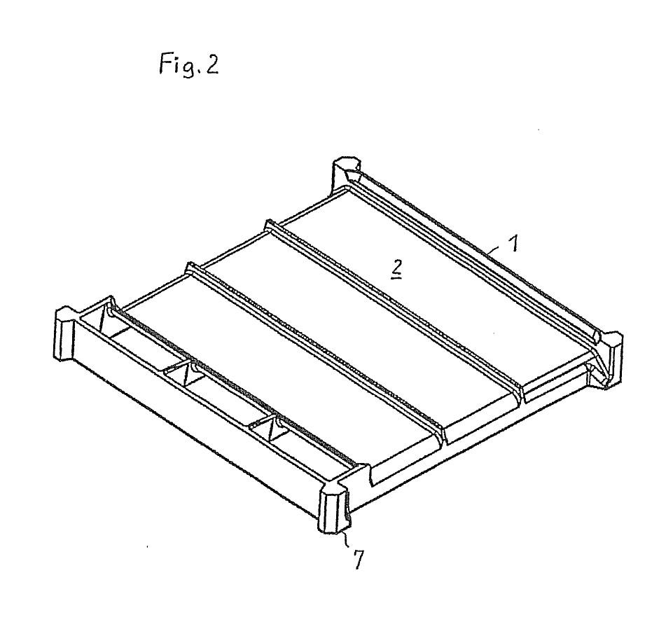

FIG. 2 is the bottom view of a foamed sieve box.

A polyurethane foam sieve box 1 of a sieve comprises a base plate 2 and partition walls 4, for receiving an insertable sieve frame 5 with battens, and also discharge channels and is delimited by side walls 3. The height of the frame of the sieve box 1 is approx. 8 cm.

Furthermore, the sieve box 1 comprises specifically configured corner pieces 7 which, on the one hand, allow good centering within the outer side walls 3 and, on the other hand, allow large discharge channels and sifting channels 6.

Two wide sifting channels 6 are provided, which are arranged between the sieve frame 5 and the outer wall of the sieve box 1. The width of these sifting channels 6 is approx. 13 cm, which allows a sifting output of approx. 35 t/h.

The foamed sieve box 1 comprises no sharp corners and edges, which simplifies cleaning. Wear is low.

The insertable sieve frame 5 of stainless steel is provided with a seal shaped to the contour, to ensure an optimum seal between the insertable sieve frame 5 and the sieve box 1.

1. Sieve for sifting a floury, granulous or granular product comprising:
a sieve box with base plate and at least one sifting duct for the product, and
an inlaid sieve frame which is covered with a sieve webbing, wherein the at least one sifting duct is at least 9 cm wide.

2. Sieve according to claim 1, wherein the sifting duct is approximately 13 cm wide.

3. Sieve according to either claim 1, wherein two sifting ducts are provided.

4. Sieve according to claim 1, wherein the sieve box is made of a plastics material.

5. Sieve according to claim 1, wherein the inlaid sieve frame is made of metal.

6. Sieve according to claim 1, wherein the sieve box has corner pieces.

7. Sieve according to claim 1, wherein the sieve box is made of a foamable plastics material.

8. Sieve according to either claim 2, wherein two sifting ducts are provided.

9. Sieve according to claim 8, wherein the sieve box is made of a foamable plastics material.

10. Sieve according to claim 9, wherein the inlaid sieve frame is made of a stainless steel.

11. Sieve according to claim 10, wherein the sieve box has corner pieces.
